(19) United States
(12) Patent Application Publication
(10) Pub. No.: US 2003/0158725 A1
(43) Pub. Date: Aug. 21, 2003

(54) Method and apparatus for identifying words with common stems

(75) Inventor: William A. Woods, Winchester, MA (US)

Correspondence Address: Therese A. Hendricks, Finnegan, Henderson, Farabow,, Garrett & Dunner, L.L.P., 1300 I Street, N.W., Washington, DC, 20005-3315, US

(73) Assignee: Sun Microsystems, Inc.

(21) Appl. No.: 10/367,453

(22) Filed: Feb. 14, 2003

Related U.S. Application Data
(60) Provisional application No. 60/357,374, filed on Feb. 15, 2002.

(51) Int. Cl. G06F 17/27

(52) U.S. Cl. 704/10

(57) ABSTRACT

Methods and systems for matching a query term Q to a text term T which are useful, for example, in information retrieval systems. A likelihood is determined whether the query term Q and the text term T share a common stem and, if the likelihood exceeds a threshold, the text term is included in a set of matched terms. The likelihood determination may be based on determining a longest shared substring of query term Q and text term T.

### PRIORITY APPLICATIONS

This application claims priority under 35 U.S.C. §120 to U.S. Provisional Application No. 60/357,374, filed Feb. 15, 2002, by William A. Woods entitled “Method and Apparatus For Identifying Words With Common Stems,” which is hereby incorporated by reference in its entirety.

### TECHNICAL FIELD

The present invention relates to methods and apparatus for identifying words or terms likely to share a common stem and may be used, for example, in an information retrieval system.

### BACKGROUND

An information retrieval system enables users to identify documents of interest by entering a search request or query. For example, a user may search for all documents that contain one or more words of interest by submitting a request incorporating Boolean logic, e.g., “identify all documents that contain word1 AND word2.”

Some retrieval systems will match a term in the request with a different, but related term. The assumption is made that the two terms refer to the same concept. Morphological variation is a source of related terms including, for example, different inflected forms of a word (e.g., “block”, “blocks”, “blocked”, “blocking”) and different derived forms of a word by addition of a prefix and/or suffix (e.g., “investigate”, “reinvestigate”, “investigation”).

One search technique which accommodates morphological variations is “stemming.” In this process, identifiable suffixes are repeatedly removed from the end of a word until nothing more can be removed, and what remains is a root or base form referred to as a “stem”. An algorithm or computer program for computing a stem is called a “stemmer”. Typically, the stem of an inflected or derived form of a word is only an approximation (of the root or base form) and does not include the normal ending (e.g., a final “e”) of the base form. Thus, removing “al” and “ation” from “computational” results in the stem “comput”, which approximates the base form “compute”. Similarly, removing “ing” from “computing” produces the same stem “comput”. Because many suffixes require removal of a final “e” before adding the suffix, stemmers will typically reduce words that end in “e” by removing the final “e,” thus producing a truncated stem that will be common with the stems of other inflected forms. In this manner, “compute”, “computes”, “computation” and “computing” will all reduce to the common stem “comput”.

According to one known method, a stemming algorithm is applied to each term of text in a document when constructing an index of terms that occur in the document. Stemming is again applied at retrieval time, to each term of the search query. Accordingly, what is indexed and what is matched are both the stems of words, rather than the words themselves. The intent here is to normalize the morphological variations of the text and query terms into a single standardized form.

The known stemming techniques have several limitations. One is that not all words that reduce to a common stem are actually related terms. For example, in one stemmer “copper”; “cop”, “cope” and “copulate” all reduce to “cop”, but are not all related concepts. To avoid this problem it would be desirable to allow a user to decide whether or not to use stemming to match a given term in a query. However, for a retrieval system to support both stemming and nonstemming require indexing of both the stemmed and unstemmed forms of a word; as a result, the process time and memory space requirements become more expensive.

Still another limitation of known stemming techniques is that they require a significant amount of language-specific knowledge. This knowledge may include which suffixes exist in a given language and the spelling conventions that apply when attaching each suffix to its respective stem. As a result, modifying a stemmer for another language requires a great deal of language-specific input and these labor-intensive modifications are required for each different language a retrieval system supports. Thus, there exists a need for an identification or retrieval system which avoids some or all of the limitations of the prior art systems.

### SUMMARY

The present invention relates to methods and systems for matching a query term Q to a text term T. The methods and systems are useful, for example, in information retrieval systems. A likelihood is determined whether the query term Q and the text term T share a common stem and, if the likelihood exceeds a threshold, the text term may be included in a set of matched terms. The likelihood determination may be based on a shared substring of Q and T.

In various method implementations consistent with the invention, a method of matching a query term to a text term is provided. The method includes steps of determining a length L_{SS} of a longest shared substring of query term Q and text term T, determining a ratio R of the length L_{SS} to a larger of a length L_{Q} of query term Q and a length L_{T} of text term T, and determining if the ratio R is greater than or equal to a threshold parameter c and if so, finding a match between the query term Q and the text term T.

In one implementation, the method is performed on a plurality of text terms. A screening step is provided to identify candidate text terms from the plurality of text terms, before proceeding with the steps of the method for each candidate text term. The screening step may comprise, for each respective text term in the plurality of text terms, determining if the length L_{T} is greater than or equal to a minimum length parameter m and if so, including the respective text term in a set of candidate text terms.

In another implementation, a length L_{Q} is determined for a query term Q, and it is determined whether the length L_{Q} is greater than or equal to a minimum length parameter m and if so, one proceeds with the method steps for comparing ratio R to length L_{SS}. Alternatively, one may include a step of screening the text terms by comparing the length L_{T} of text term T to minimum length parameter m, before proceeding with comparing ratio R to length L_{SS}.

In an alternative implementation for screening the plurality of text terms, the candidate text terms are identified using an alphabetically ordered list, in which the candidate text terms form a block of successive text terms. A query threshold substring QS_{c} can be used as a search key, in a form of binary search, to find the block of successive text terms.

In a further implementation, the step of screening the plurality of text terms may be performed by determining if a text term T has a length L_{T} which is greater than or equal to a length L_{QSc}, where a length L_{QSc} is an integer part of the product of the query term length L_{Q} and the threshold parameter c.

In a further implementation, the step of screening the plurality of text terms may include determining if an initial substring of text term T of length L_{QSc} is equal to a query threshold substring QS_{c}, whose length L_{QSc} is an integer part of the product of the query term length L_{Q} and the threshold parameter c, and QS_{c} is an initial substring of the query term Q of length L_{QSc}.

In another implementation, a computer-readable medium is provided containing instructions to perform any of the described methods for matching a query term Q to a text term T.

In another implementation, an apparatus is provided with means for determining the length L_{SS}, means for determining the ratio R, and means for determining if the ratio R is greater than or equal to the threshold parameter c.

In another implementation, an information retrieval system is provided for identifying text terms or documents containing text terms of interest to a user entering a search request. The system includes a computer-readable medium containing instructions to perform a method of matching a query term Q of the search request to a text term T. The method of matching may include any of the described method implementations.

In a further implementation, a text retrieval system is provided which includes an index of terms that occur in one or more texts. A computer-readable medium is provided containing instructions to perform a method, the method including matching one or more terms in a query with one or more terms in the index that are determined likely to share a stem with the one or more query terms, and computing a degree to which each matched text term is determined likely to share a stem with the one or more query terms.

In yet a further implementation, an apparatus is provided for matching a query term Q and a text term T including at least one memory having program instructions, and at least one processor configured to execute the program instructions to perform the operations of determining the length L_{SS}, determining the ratio R, and determining if the ratio R is greater than or equal to the threshold parameter c.

In another implementation, a method is provided of matching a query term Q to a text term T which includes computing a shared substring function F_{SS} for the query term Q and text term T that is correlated with the likelihood that the two terms share a common stem, and that if function F_{SS} exceeds a threshold, finding a match between the query term Q and the text term T.

In this method, the function F_{SS} may include a ratio of a length of a longest common substring of query term Q and text term T to a function of length L_{Q} of the query term Q and L_{T} of the text term T. Further, the function F_{SS} may be used to determine a numerical weight for a match between the query term Q and the text term T.

In yet another implementation, the method includes a step of first checking the query term Q in an exceptions table and if Q occurs in that table, then finding a match to text term T if and only if T is listed as a match for Q in the exceptions table.

In another implementation, a step is provided of checking the query term Q and the text term T against a table of pattern pairs and rejecting a match if a pattern pair occurs in that table, one of whose patterns matches Q and the other of whose patterns matches T.

In yet another implementation, a method is provided for determining a set of likely morphological variants of a term Q by analyzing a collection of terms T and identifying one or more of the terms T that are sufficiently similar to Q. This method may include the step of computing for the query term Q and the text term T a shared substring function F_{SS} that is correlated with the likelihood that the two terms share a common stem. If this function F_{SS} exceeds a threshold, then the term T is selected as a variant of query term Q.

In the various implementations described in this application, the order of method steps or arrangement of apparatus elements provided is not limiting unless specifically designated as such.

### BRIEF DESCRIPTION OF THE DRAWINGS

FIG. 1 is a schematic diagram of two working buffers into which a query term Q and a text term T may be loaded, according to an implementation consistent with the present invention.

FIG. 2 (including FIGS. 2A and 2B) is a flow chart of a procedure applied to a query term Q for determining text terms T likely to share a common stem with Q, according to one implementation consistent with the present invention.

FIG. 3 is a flow chart of an alternative method implementation consistent with the present invention.

FIG. 4 is a flow chart of yet another method implementation consistent with the present invention.

FIG. 5 is a diagram of an exemplary computing system with which the implementations described herein may be used.

### DETAILED DESCRIPTION

Various implementations of the present invention will now be described. These methods and systems have an advantage in accommodating morphological variation in a manner that does not depend on language-specific rules and that would apply to many languages. Generally, a procedure is provided for determining a set of expansion terms that have been found likely to share a common stem with a query term Q.

In various implementations, an information retrieval system may be provided in which, rather than collapsing all variations of a term into a single stem and then indexing that stem, instead the system indexes the terms that actually occur in the text. Then subsequently, upon retrieval, a procedure is provided which determines a measure of the degree to which a query term and a text term are likely to share a common stem. No stems need be created. Rather, each term in a query can be expanded with all of the terms of the indexed text found likely to share a stem with it. These expansion terms can be accepted as alternative matches to the query term. Thus, if Q is a term of a query, the retrieval system will return not only exact matches for the term Q, but also any matches for the expansion terms of Q.

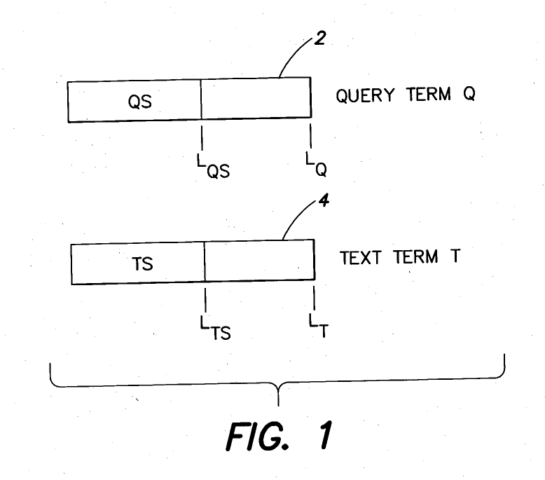

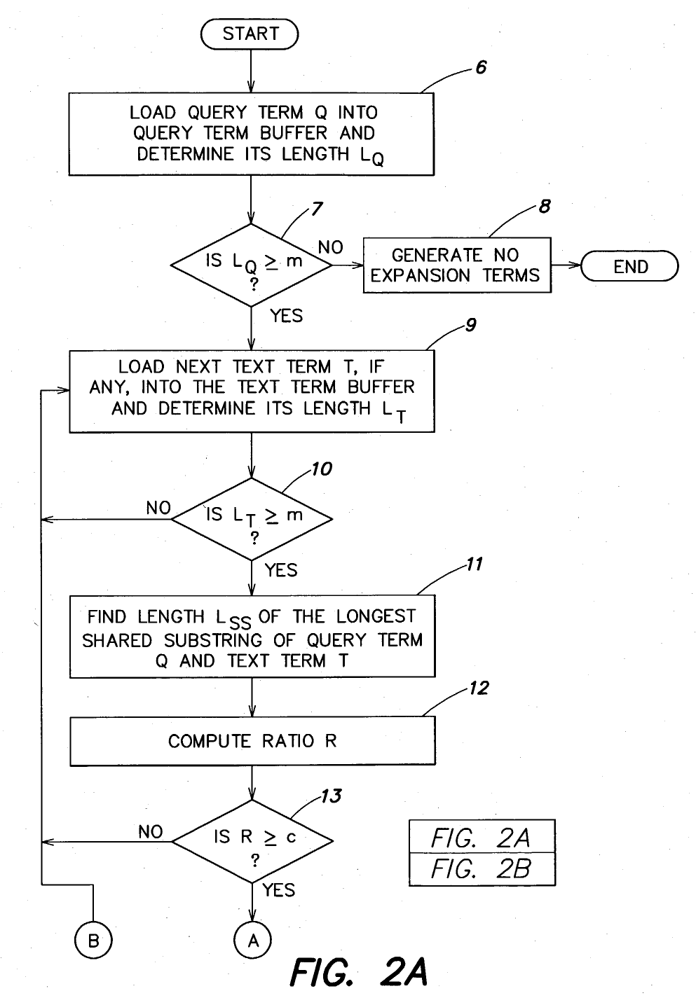

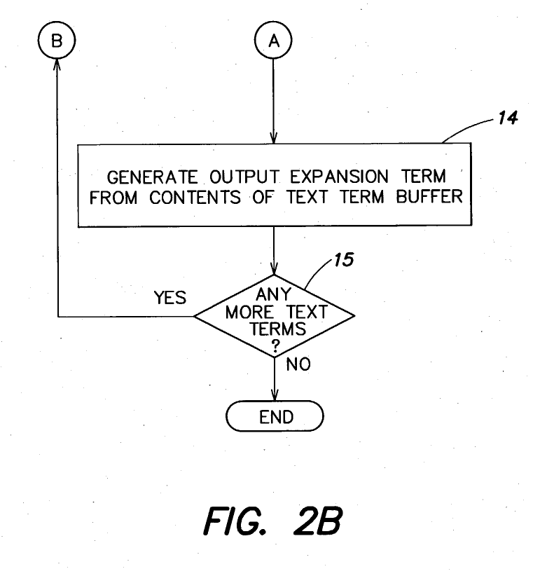

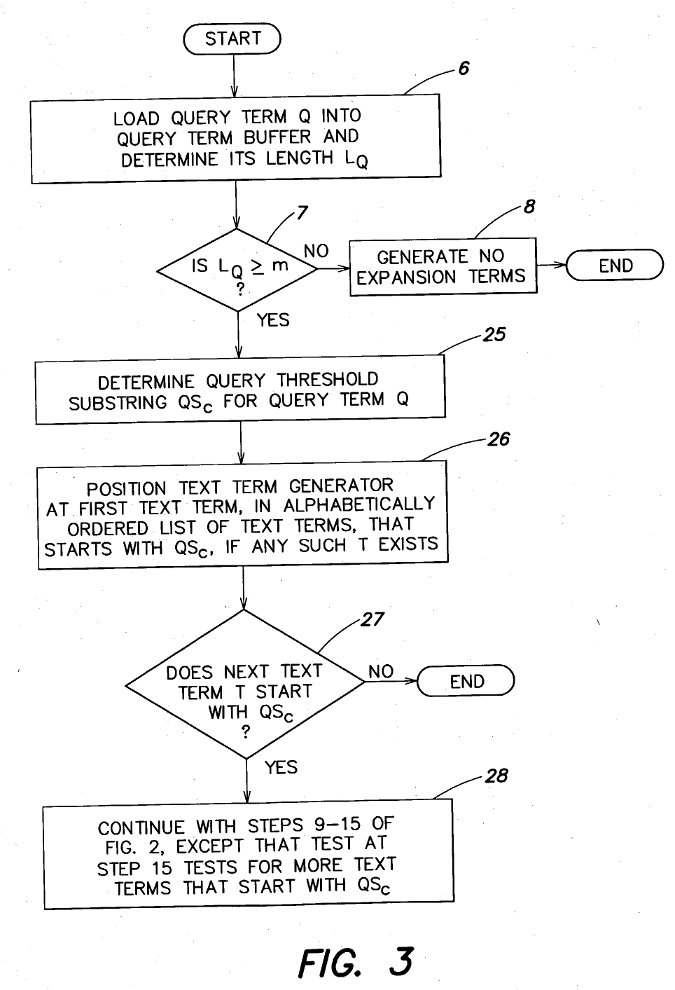

FIGS. 1-2 illustrate a method implementation consistent with the present invention for matching a query term Q with a text term T. This method may be incorporated in a text retrieval system and may be implemented in a program of instructions provided on a computer-readable medium. Further, an apparatus may be provided for implementing the method, the apparatus including at least one memory having program instructions, and at least one processor configured to execute the program instructions to perform the operations of the method described below.

FIG. 1 (upper portion) shows a query term Q having a length L_{Q} equal to the number of characters in Q. The query term Q is shown stored in a buffer 2. An initial portion of the query, referred to as a query substring QS having a length L_{QS}, is also shown.

FIG. 1 (lower portion) similarly shows a text term T having a length L_{T} equal to the number of characters in T. The text term T is stored in buffer 4 and an initial text substring TS of length L_{TS} is shown.

Table 1 defines various nomenclature used in this example for both the query and text terms, their initial substrings, and for certain user-defined or specified parameters and other computed values.

TABLE 1

Q = query term
QS = query substring
QS_{c} = query threshold substring
T = text term
TS = text substring
T_{C} = candidate text term
T_{E} = expansion text term
c = threshold parameter
m = minimum length parameter
L_{QSc} = integer part of (L_{Q} × c)
L_{SS} = length of longest shared substring of Q and T
R = ratio of L_{SS} to larger of L_{Q} and L_{T}
L_{Q} = length of Q
L_{QS} = length of QS
L_{QSc} = length of QS_{c}
L_{T} = length of T
L_{TS} = length of TS

FIG. 2 is a flow chart illustrating the steps of one procedure for comparing a text term T to a query term Q, in order to determine whether T is likely to share a common stem with Q. Overall this procedure or algorithm will determine a set of zero, one or more expansion terms T_{E} that include not only exact matches for the query term Q, but also terms found likely to share a common stem with Q.

In a first step, a query term Q is selected to which the following sequence of steps will be applied. The selected Q is loaded into a query term buffer and its length L_{Q} is computed (step 6). In a next step 7, L_{Q} is compared to an input parameter m. The parameter m specifies a minimum term length required for both Q and T in order for T to be considered as a possible expansion term T_{E} for Q, i.e., determined likely to have the same stem as Q. In this step, if L_{Q} is less than m, then no matches (expansion terms) are possible and the method ends (step 8).

If L_{Q} is greater than or equal to m, then the method proceeds to a first subroutine (steps 9-10) in which all text terms T are screened for possible expansion terms, here referred to as candidate text terms T_{C}. In this subroutine, a selected text term T is loaded into a text term buffer and its length L_{T} is computed (step 9). Then L_{T} is compared with input parameter m (step 10). If L_{T} is greater than or equal to m, the selected text term T is determined to be one of a set of candidate text terms T_{C}. However, if L_{T} is less than m, i.e., less than the minimum length specified by m, then T cannot be a T_{C}. All text terms are thus screened before proceeding to the next subroutine.

In the next subroutine (steps 11-13), it is determined which candidate text terms T_{C} are expansion terms T_{E} (matches for Q determined likely to share a common stem). For each T_{C}, a length L_{SS} of the longest shared initial substring of Q and T is computed (step 11). Next, a ratio R of L_{SS} to the larger of L_{Q} and L_{T} (for that T_{C}) is computed (step 12). Then, R is compared to input parameter c (step 13). If R is greater than or equal to threshold parameter c, an effective match is found and this T_{C} is output as one of a set of expansion terms T_{E} (step 14). If more text terms exist (step 15), then the method continues (return to step 9) checking each candidate text term T_{C} to determine if it is an expansion term.

The input parameter c is a threshold size factor for finding a common substring. More specifically, parameter c is used to compute a required length, L_{QSc}, of an initial substring QS_{c} of query term Q, where L_{QSc} is the integer part of the product L_{Q}×c. As an example, if c=0.5 or ½, then L_{QSc} is the integer part of (L_{Q}×½); i.e., half of L_{Q} if L_{Q} is even, and half of L_{Q}−1 if L_{Q} is odd. It can be seen that the larger the value of input parameter c, the longer the common substring that is required for Q and T. Thus, an input value of c=0.5 will accept “pace” and “pacing” as likely to share a common stem, while an input value of c=0.6 will not (here the common initial substring is “pac” and L_{SS} is 3; the ratio R of L_{SS} to the larger of L_{Q} and L_{T} is 3/6=0.5; thus R is greater than or equal to c where c=0.5, but not where c=0.6). In summary, input parameter c is the minimum (threshold) value of R required for text term T to be found to be an expansion term, i.e., determined likely to share a common stem.

It can be desirable to use different values of input parameter c to improve the search results for different types of documents (e.g., emails, memoranda, scientific publications) and/or for text in different languages. Typically, a value of 0.5 or greater is useful. In one implementation, a value of c=0.6 was found effective for searches of English-language documents. A retrieval system may allow a human searcher to select the value of c, either directly or by some choice made in a user interface or configuration file.

The second input parameter m is optional (not required) and can be used to avoid the generation of false variants for short words. As an example, a value of m=4 was used in one implementation to block the variant “cope” for “cop”. However, it also rejected “cops” for “cop”, which a minimum length of m=3 would have accepted. As another example, a minimum length of at least m=3 is useful to avoid determining that “off” shares a common stem with “of”.

In an alternative methodology to that of FIG. 2, text terms are generated from an alphabetically ordered list of all of the text terms in such a way that only text terms T that start with a query threshold substring QS_{c} need to be considered and these can be found and enumerated efficiently. This alternative method is shown in FIG. 3. The query threshold substring QS_{c} is defined as the initial substring of query term Q of length L_{QSc}, where L_{QSc} is defined as the integer part of the product L_{Q}×c.

As shown in FIG. 3, the initial steps 6, 7 and 8 are the same as in FIG. 2. After the query term Q is loaded into the query term buffer and it's length L_{Q} is computed (step 6), a test verifies that the length of query Q is greater than or equal to the minimum length parameter m (step 7) and if not no expansion terms are generated (step 8). If the length L_{Q} is greater than or equal to the threshold m, then the query threshold substring QS_{c} is determined for query term Q (step 25). A text term generator is then positioned, in an alphabetically ordered list of text terms, at a first text term that starts with the query threshold substring QS_{c}, if any such term exists. When such a term exists, the text term generator is positioned at the point in the alphabetical list of text terms where the next generated term will be this identified text term T. This first text term will be the beginning of a block of text terms (possibly only one) that all start with the query threshold substring QS_{c}. Only the text terms in this block need to be considered by the rest of the algorithm, which continues with steps 9-15 of FIG. 2, except that the test at step 15 checks for more text terms that start with threshold substring QS_{c}.

In one implementation, the first text term T satisfying the threshold condition (when it exists) can be found with a form of binary search in which the threshold substring QS_{c} can be used as the search key. Other efficient algorithms for looking up strings in ported lists, such as m-way search and skip lists, can also be used. If no such term exists, the algorithm ends with no expansion terms (step 27). If an initial text term T satisfying this threshold condition is found, successive terms from the alphabetized list of text terms are considered until the first term is encountered that no longer starts with the initial substring QS_{c} (step 28). Once the first text term that does not satisfy the threshold condition has been encountered, all of the text terms that could possibly satisfy the conditions of steps 11-13 (of FIG. 2) would have been considered and the process can end.

At least one method or algorithm in accordance with the invention has been implemented in the Java™ programming environment and used in an information retrieval system. It was found effective for dealing with morphological variations of English words. Because the method does not depend on language-specific rules, it can be applied to text in many languages. Also the method not only determines whether two terms are likely to share a stem, but also computes the ratio R that estimates the likelihood or the degree to which two terms appear to share a stem. This ratio can then be used for relative ranking of the expansion terms.

The method does not require modifying the terms of documents that are indexed. Rather, it compares query terms to indexed text terms, where the index contains complete information about which forms of the words occurred in the documents. Thus, it is easy to support query operators that indicate whether or not to use shared stem matching, or to use some other technique that requires the full word (rather than a stem) in the index.

The method may find some matches that would not be found by a traditional stemmer; it may also avoid some false matches that a traditional stemmer would find. For example, depending on the values of the input parameters c and m, the method could determine that “cop”, “cope”, or “copper” are not likely to share a stem with “copulate” (although it could determine that “cop” and “cope” might share a stem, for some settings of the parameters).

Other implementations of the invention may adjust the denominator and/or the numerator of the ratio R and/or the value of the threshold parameter c, as a function of the lengths of the query and/or text terms or the length of the common substring. Alternatively, a method consistent with the invention may compute some other function of the length of the longest common substring and the lengths of the terms. For example, although c is a constant in the above implementations, the invention allows for making the threshold c into a variable that could be lower for shorter words according to some function. This would compensate for the fact that shorter words necessarily have a more limited length for the common substring, and this would be a smaller proportion of the overall length of an inflected form, than for longer words. For example, “puts” and “putting” have a common initial substring of only 3 characters, which is less than half the length of “putting”. This is less of a factor for longer words.

Other implementations of the invention can be based on internal shared substrings (not necessarily initial), in order to deal with prefixes as well as suffixes. Further, more than one shared (common) internal substring can be used to deal with vowel shifts and other internal variations. For example, by checking all of the indexed text terms T that contain an internal substring of length L_{TS} of at least L_{QS} that is identical to an internal substring of Q, and then computing the ratio R of the length of this substring L_{TS} to the greater of L_{T} and L_{Q}, the method can identify terms T that might share a stem with Q via a prefix relationship, as well as a possible suffix relationship—e.g., “reanimate” and “animated” would share the internal substring “animate”, and the ratio R would be 0.778.

Various implementations of the invention can be utilized alone or in combination with methods utilizing language-specific knowledge. For example, a table of ending pairs may indicate that two terms should not be found to have the same stem. In this example, if a query term and a text term identified as a term expansion by an algorithm of the invention differ in having endings that are one of the pairs in the table, then that text term can be suppressed as a term expansion for that query term. Thus, if the pair {“”,“e”} were stored in such a table, indicating that two terms differ only in that one ends in “e” and the other does not, then the resulting algorithm would reject false matches for pairs such as “cop” and “cope”, “slop” and “slope”, and “dot” and “dote”.

The invention can also be combined with language-specific information such as an “exceptions list” of terms to be treated specially. This list can be utilized together with the term variations that are to be generated as expansion terms. If a query term is found in this list, then the associated terms (if any) are generated and the algorithm of the invention (for example FIG. 2) need not be applied. This allows for the special handling of irregular words, words that do not undergo inflection, and/or special cases of words where the general method would falsely generate known unrelated terms. For example, it could handle the morphological relationships among the related terms “know”, “knows”, “knew”, “known” and “knowing”.

The method of the invention can be combined with language-specific morphological rule systems or other morphological systems in order to find additional related terms that the morphological system did not recognize. In this case, terms generated by the algorithm of the invention would be added to the terms generated by the other system.

Various implementations consistent with the invention not only determine whether two terms are likely to share a common stem, but also determine a computed value (the ratio R) correlated with the likelihood that they share a stem. This computed value can be used to adjust the relative weight or importance (rank) of an expansion term in a retrieval request. This is useful in a retrieval system that uses term weights as part of its calculation of relevance between a query and a document (or text passage). Expansion terms that are more likely to share a stem with a query term would thus be weighted more highly.

In addition, calibration experiments can be conducted to produce a table or transformation function that would transform this computed value (e.g., the ratio R) into an equivalent probability or likelihood ratio. This technique can be integrated with probabilistic retrieval techniques and other probabilistic methods.

While the methods described here are in the context of an information retrieval system, the method can be used in any context in which it is desirable to determine whether two terms are morphologically related or have the same stem or to measure the degree to which two terms are likely to be morphologically related or have the same stem. Other examples include fuzzy matching in translation memories, or in sentence alignment algorithms for cross-lingual text alignment, document similarity and clustering, and spam filtering.

A query term Q as used herein is not limiting and is meant to be interpreted broadly. It may be an actual term included in a search query, or any term that is to be compared to another term T. In various implementations it includes what may be referred to as a source term, such as used in an alignment algorithm.

A text term T is also used broadly and is generally understood to include one or more characters, symbols or other textual objects; it may, for example, be comprised of alpha-numericals or non-Roman based characters.

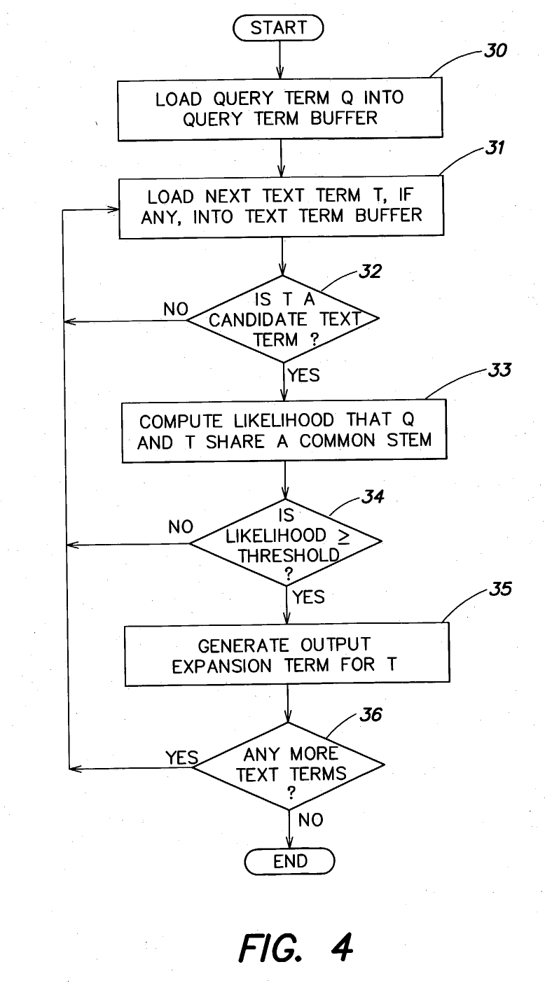

A more generalized and further method implementation is shown by the flow chart of FIG. 4. This method may alternatively incorporate one or more of the previous method steps described.

In FIG. 4, a query term Q is first loaded into a query term buffer (step 30). A (next) text term T is loaded into a text term buffer (step 31). It is then determined whether T is a candidate text term (step 32). If not, the method returns to step 31. If T is a candidate text term, then a likelihood that Q and T share a common stem is computed (step 33). Next, it is determined whether the likelihood is greater than or equal to a threshold parameter (step 34). If not, the method returns to step 31. If the likelihood is greater than or equal to a threshold parameter, then an output expansion term is generated for this text term T (step 35). It is then determined whether there are any more text terms (step 36) and if so, the method returns to step 31. If not, the method ends.

The invention also includes systems and apparatus for performing these various method operations. The apparatus may be specially constructed for the required purpose, or it may comprise a general purpose computer selectively activated or configured by a computer program stored in the computer. The algorithms presented herein are not inherently related to any particular computer or other apparatus.

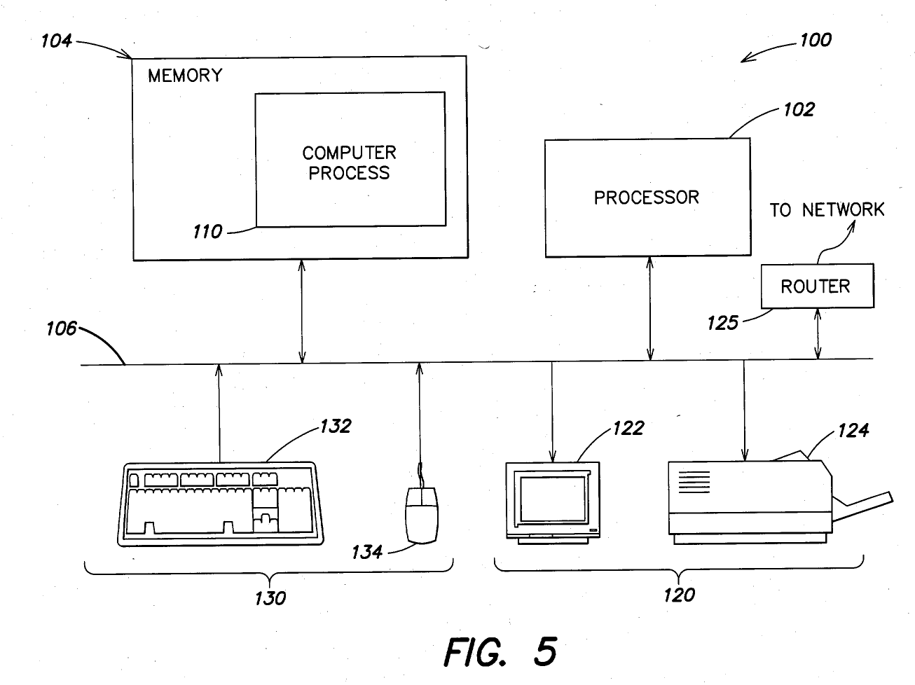

FIG. 5 is a diagram of an exemplary computer system 100 that can carry out processes consistent with the invention. Computer system 100 includes a processor 102 and a memory 104 coupled to processor 102 through a bus 106. Processor 102 fetches computer instructions from memory 104 and executes those instructions. Processor 102 can also: (1) read data from and write data to memory 104; (2) send data and control signals through bus 106 to one or more computer output devices 120; (3) receive data and control signals through bus 106 from one or more computer input devices 130 in accordance with the computer instructions; and (4) transmit and receive data through bus 106 and router 125 to a network.

Memory 104 can include any type of computer memory including, without limitation, random access memory (RAM), read-only memory (ROM), storage devices that include storage media such as magnetic and/or optical disks, and network-based memory devices. Memory 104 includes a computer process 110, which may comprise a collection of computer instructions and data that collectively define a task performed by computer system 100.

Computer output devices 120 can include any type of computer output device, such as a printer 124 or a display 122, e.g., a cathode ray tube (CRT), a light-emitting diode (LED) display, or a liquid crystal display (LCD). Display 122 may display the graphical and textual information received from a computer process. Each of computer output devices 120 receives from processor 102 control signals and data and, in response to such control signals, displays data.

User input devices 130 can include any type of user input device such as a keyboard 132, keypad, or a pointing device, such as an electronic mouse 134, a trackball, a lightpen, a touch-sensitive pad, a digitalizing table, thumb wheels, or a joystick. Each of user input devices 130 can be used to generate signals in response to physical manipulation by a user and transmits those signals through bus 106.

Other implementations consistent with the invention will be apparent to those skilled in the art from consideration of the specification and practice of the invention disclosed herein. It is intended that the specification and implementations be considered as exemplary only, with a true scope of the invention being indicated by the following claims.

1. A method of matching a query term Q to a text term T comprising:
determining a length L_{SS} of a longest shared substring of query term Q and text term T;
determining a ratio R of length L_{SS} to a larger of a length L_{Q} of query term Q and a length L_{T} of text term T; and
determining if the ratio R is greater than or equal to a threshold parameter c and if so, finding a match between the query term Q and the text term T.

2. The method of claim 1, wherein the method is performed on a plurality of text terms.

3. The method of claim 2, further including screening the plurality of text terms to identify candidate text terms, before proceeding with the steps of the method for each candidate text term.

4. The method of claim 3, wherein the candidate text terms are identified using an alphabetically ordered list, in which the candidate text terms form a block of successive text terms.

5. The method of claim 4, wherein the block of successive text terms starts with a query threshold substring QS_{c}.

6. The method of claim 5, wherein a form of binary search or other efficient search algorithm, with the query threshold substring QS_{c} as a search key, is used to find the block of successive text terms.

7. The method of claim 3, wherein the screening step comprises:
determining if the text term length L_{T} is greater than or equal to a length L_{QSc}, where the length L_{QSc} is an integer part of a product of the query term length L_{Q} and the threshold parameter c.

8. The method of claim 3, wherein the screening step comprises:
determining if an initial substring of text term T of length L_{QSc} is equal to a query threshold substring QS_{c}, where the length L_{QSc} is an integer part of a product of the query term length L_{Q} and the threshold parameter c, and QS_{c} is an initial substring of the query Q of length L_{QSc}.

9. The method of claim 3, wherein the screening step comprises:
determining if the length L_{T} of text term T is greater than or equal to a minimum length parameter m and if so, including the text term T in a set of the candidate text terms.

10. The method of claim 1, wherein the value of m is at least 3.

11. The method of claim 2, further comprising a first screening step of:
determining if the length L_{Q} is greater than or equal to a minimum length parameter m and if so, proceeding with the steps of the method.

12. The method of claim 11, wherein the value of m is at least 3.

13. The method of claim 11, further including a second screening step of:
determining if the length L_{T} is greater than or equal to a minimum length parameter m and if so, proceeding with the steps of the method.

14. The method of claim 13, wherein the value of c is at least 0.5 and the value of m is at least 3.

15. The method of claim 1, wherein the value of c is at least 0.5.

16. A computer-readable medium containing instructions to perform a method of matching a query term Q to a text term T, the method comprising:
determining a length L_{SS} of a longest shared substring of query term Q and query term T;
determining a ratio R of length L_{SS} to a larger of a length L_{Q} of query term Q and a length L_{T} of text term T; and
determining if the ratio R is greater than or equal to a threshold parameter c and if so, finding a match between the query term Q and the text term T.

17. An apparatus comprising:
means for determining a length L_{SS} of a longest shared substring of a query term Q and a text term T;
means for determining a ratio R of length L_{SS} to a larger of a length L_{Q} of query term Q and a length L_{T} of text term T; and
means for determining if ratio R is greater than or equal to a threshold parameter c and if so, finding a match between the query term Q and the text term T.

18. An information retrieval system for identifying text terms or documents containing text terms of interest to a user entering a search request, the system including a computer-readable medium containing instructions to perform a method of matching a query term Q of the search request to a text term T, the method comprising:
determining a length L_{SS} of a longest shared substring of query term Q and text term T;
determining a ratio R of length L_{SS} to a larger of a length L_{Q} of query term Q and a length L_{T} of text term T; and
determining if ratio R is greater than or equal to a threshold parameter c and if so, finding a match between the query term Q and the text term T.

19. A text retrieval system comprising:
an index of terms that occur in texts;
a computer-readable medium containing instructions to perform a method, the method comprising:
matching one or more terms in a query with one or more terms in the index that are determined likely to share a stem with the one or more query terms; and
computing a degree to which each matched text term is determined likely to share a stem with the one or more query terms.

20. The system of claim 19, wherein the likelihood determination is based on determining a longest shared substring of the query term Q and the index term.

21. The system of claim 20, wherein the degree determination is based on a length of the largest shared substring.

22. An apparatus for matching a query term Q with a text term T including at least one memory having program instructions, and at least one processor configured to execute the program instructions to perform the operations of:
determining a length L_{SS} of a longest shared substring of query term Q and text term T;
determining a ratio R of L_{SS} to a larger of a length L_{Q} of query term Q and a length L_{T} of text term T; and
determining if ratio R is greater than or equal to a threshold parameter c and if so, finding a match between query term Q and the text term T.

23. A method of matching a query term Q to a text term T comprising computing a shared substring function F_{SS} from the query term Q and text term T that is correlated with a likelihood that the two terms share a common stem, and if this function F_{SS} exceeds a threshold, finding a match between the query term Q and the text term T.

24. The method of claim 23, wherein the function F_{SS} comprises a ratio of a length of a longest common substring of query term Q and text term T to a function of the lengths L_{Q} and L_{T} of the query term Q and the text term T, respectively.

25. The method of claim 24, wherein the function F_{SS} comprises a ratio of a length of a longest common initial substring of query term Q and text term T to a larger of the lengths L_{Q} and L_{T}.

26. The method of claim 23, further comprising use of the computed function F_{SS} to determine a numerical weight to a match between the query term Q and the text term T.

27. The method of claim 23, further comprising a step of first checking the query term Q in an exceptions table and if Q occurs in that table, then finding a match to text term T if and only if T is listed as a match for Q in the exceptions table.

28. The method of claim 23, further comprising a step of checking the query term Q and the text term T against a table of pattern pairs and rejecting a match if a pattern pair occurs in that table, one of whose patterns matches Q and the other of whose patterns matches T.

29. A method of determining a set of likely morphological variants of a term Q by analyzing a collection of terms T and identifying one or more of the terms T that are sufficiently similar to term Q.

30. The method of claim 29, further comprising steps of computing, for the term Q and each term T, a shared substring function F_{SS} that is correlated with a likelihood that the two terms share a common stem, and if this function F_{SS} exceeds a threshold, selecting the term T as a variant of the term Q.

31. The method of claim 30, wherein the function F_{SS} comprises a ratio of a length of a longest common substring of term Q and term T to a function of lengths L_{Q} and L_{T} of the terms Q and T, respectively.

32. The method of claim 31, wherein the function F_{SS} comprises a ratio of a length of a longest common initial substring of term Q and term T to a larger of the lengths L_{Q} and L_{T}.
